(19) United States
(12) Patent Application Publication
(10) Pub. No.: US 2006/0085509 A1
(43) Pub. Date: Apr. 20, 2006

(54) Server based constraint of mail folder content through filters

(75) Inventor: Michael Wener, Munising, MI (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/174,290

(22) Filed: Jun. 30, 2005

Related U.S. Application Data
(60) Provisional application No. 60/619,071, filed on Oct. 15, 2004.

(51) Int. Cl. G06F 15/16

(52) U.S. Cl. 709/206

(57) ABSTRACT

The present invention provides a way to allow the user to restrict message sets per folder. The invention allows a mail client to offload the burden of automatically constraining the mail content seen at the mobile device. The constraints are fully configurable and manageable by the client at a per mailbox level. There are numerous advantages to the invention including that of a less cluttered mail box and the constraining criteria is user selectable and dynamically configurable.

### FIELD OF INVENTION

The invention relates generally to e-mail access technologies and deals more specifically with mobile e-mail.

### BACKGROUND OF THE INVENTION

In a mobile environment it is often desirable to allow a user to restrict or constrain the set of messages that will be sent to the mobile device. There may be several reasons. The user may not want to pay for the bandwidth consumed, they may not want to consume memory on the phone or they may just want to restrict what they get “bothered” by while in a mobile environment. Therefore, the amount of mail content to be delivered to the user and/or the mobile device needs to be constrained.

The prior art approach to solving this problem is to place the burden on the user to manually select mail that is wanted on the phone from all of the e-mail messages. The problem is that all messages in the user's mailbox are downloaded including those that are not wanted or desired.

One prior art approach to filtering messages proposed by the Internet Society and referred to as the Lemonade profile allows clients to submit new email messages incorporating content which resides on locations external to the client (“forward without download”) and to optimize e-mail exchanges between clients and servers in a mobile environment. This approach relies upon extensions to other protocols; specifically URLAUTH, CATENATE, Lemonade Command Extensions in the IMAP protocol [RFC 3501] and BURL in the SUBMIT protocol [RFC 2476]. The approach also attempts to provide optimization in a mobile setting, aimed at delivering extended functionality for mobile devices with limited resources by relying on Lemonade Server to Client Notifications to support to push crucial changes actively to a client, rather then requiring the client to initiate contact to ask for state changes. In addition, the Lemonade profile contains Lemonade Command extensions for email filter management, message delivery, maintaining up-to-date personal information and quick reconnect. In the examples, “C:” and “S:” indicate lines sent by the client and server respectively.

The Lemonade Pull Model describes exchanges between Lemonade Agents to allow clients to submit new email messages incorporating content which resides on locations external to the client. The advent of client/server email using the [RFC3501] and [RFC2821] protocols has changed what formerly were local disk operations to become excessive and repetitive network data transmissions. This is an onerous burden for clients operating over low-bandwidth and/or high-latency links. The Lemonade Pull Model makes use of the [BURL] SUBMIT extension to enable access to external sources during the submission of a message. In combination with the IMAP [URLAUTH] extension, inclusion of message parts or even entire messages from the IMAP mail store is possible with a minimal trust relationship between the IMAP and SUBMIT servers. Pull maintains one submission protocol, and thus avoids the risk of having multiple parallel and possible divergent mechanisms for submission. Furthermore, by keeping the details of message submission in the SUBMIT server, the Lemonade Pull Model can work with other message retrieval protocols such as POP, NNTP, or whatever else may be designed in the future.

The act of sending an email message is best thought of as involving multiple steps: initiation of a new draft, draft editing, message assembly, and message submission. Initiation of a new draft and draft editing takes place on the MUA. Frequently, users choose to save more complex and/or time-consuming messages on an [RFC3501] server (via the APPEND command with the \Draft flag) for later recall by the MUA and resumption of the editing process. Message assembly is the process of producing a complete message from the final revision of the draft and external sources. At assembly time, external data is retrieved and inserted in the message. Message submission is the process of inserting the assembled message into the [RFC2821] infrastructure, typically using the [RFC2476] protocol. Traditionally, messages are initiated, edited, and assembled entirely within an MUA, although drafts may be saved to an [RFC3501] server and later retrieved from the server. The completed text is then transmitted to an MSA for delivery.

There is often no clear boundary between the editing and assembly process. If a message is forwarded, its content is often retrieved immediately and inserted into the message text. Similarly, once external content is inserted or attached, the content is usually retrieved immediately and made part of the draft. As a consequence, each save of a draft and subsequent retrieve of the draft transmits that entire (possibly large) content, as does message submission. In the past, this was not much of a problem, because drafts, external data, and the message submission mechanism were typically located on the same system as the MUA. The most common problem was running out of disk quota. The model distinguishes between a Messaging User Agent (MUA), an IMAPv4Rev1 Server ([RFC3501]) and a submit server ([RFC2476]), as illustrated in FIG. 1.

The Lemonade Pull Model allows a Messaging User Agent to compose and forward an e-mail combining fragments that are located in an IMAP server, without having to download these fragments to the server. In the [BURL]/[CATENATE] variant of the pull strategy, messages are initiated and edited within an MUA. The [CATENATE] extension to [RFC3501] is then used to upload the message to the IMAP server and assemble it, and finally a [URLAUTH] format URL is given to a [RFC2476] server with the [BURL] extension for submission.

The flow involved to support such a use case consists of:

M: {to S1—Optional} The client uses IMAP Fetch of body structures (See [RFC3501])

M: {to S1} The client invokes CATENATE (See [CATENATE] for details of the semantics and steps ?s allows the MUA to create messages on the IMAP using new data combined with body structure already present on the IMAP server.

S1: {to M} OK (See [CATENATE]).

M: {to S1} The client uses GENURLAUTH command to request and URLAUTH URL (See [URLAUTH]).

S1: {to M} The IMAP server returns URLAUTH URL suitable for later retrieval with URLFETCH (See [URLAUTH] for details of the semantics and steps).

M: {to S2} The client connects to the submission server and starts a new mail transaction. It uses BURL to let the submit server fetch the content of the message from the IMAP server (See [BURL] for details of the semantics and steps ?s allows the MUA to authorize the submit server to access the message composed as a result of the CATENATE step).

S2: {to S1} The submission server uses URLFETCH to fetch the message to be sent (See [URLAUTH] for details of the semantics and steps. The so-called “pawn-ticket” authorization mechanism uses a URI which contains its own authorization credentials.).

S1: {to S2} Provides the message composed as a result of the CATENATE step).

S2: {to M} OK (2XX)

The messaging user agent, mail server and submit server MUST support IMAPv4 Rev1 [RFC3501], CATENATE [CATENATE] and URLAUTH [URLAUTH]. The so-called “pawn-ticket” authorization mechanism uses a URI which contains its own authorization credentials using [URLAUTH]. The advantage of this mechanism is that the submit [RFC2476] server cannot access any data on the [RFC3501] server without a “pawn-ticket” created by the client. The “pawn-ticket” grants access only to the specific data that the submit [RFC2476] server is authorized to access, can be revoked by the client, and can have a time-limited validity.

The “fcc problem” refers to a frequent need to deliver a copy of the message to a “file carbon copy” recipient. By far, the most common case of fcc is a client leaving a copy of outgoing mail in a “sent messages” or “outbox” mailbox. In the traditional strategy, the MUA duplicates the effort spent in transmitting to the MSA by writing the message to the fcc destination in a separate step. This may be a write to a local disk file or an APPEND to a mailbox on an IMAP server. The latter is one of the “excessive and repetitive network data transmissions” which represents the “problem” aspect of the “fcc problem”. The [CATENATE] extension to [RFC3501] addresses the fcc problem. It requires making several simplifying assumptions:

(1a) there is one, and only one, fcc destination on a single server

(2a) the server which holds the fcc is the same as the server which stages the outgoing message for submission

(3a) it is desired that the fcc be a copy of the complete message text with all external data inserted in the message

Mobile optimizations that defines extensions to the IMAPv4 Rev1 protocol [RFC3501] aimed at delivering extended functionality for mobile devices with limited resources including support to push crucial changes actively to a client, rather then requiring the client to initiate contact to ask for state changes and extensions for email filter management, message delivery, and maintaining up-to-date personal information and quick reconnect.

The Lemonade profile provides optimizations for the exchanges between a mobile client and e-mail server by specifying additional enhancements for optimization in a mobile setting. Thus, the client devices in this profile are assumed to be mobile with limited resources. This profile takes into account the limited resources of mobile devices, as well as extra functionality desired.

FIG. 2 illustrates the exchanges specified by the mobile optimizations of the Lemonade Profile.

A disconnected mobile client should behave like a good disconnected client [IMAP-DISC].

Today, most of the existing email clients have a polling model, where the end user is notified of changes to an email account only after his/her email client asks the server, called polling. How long it takes a client to learn of a change on the server is thus dependent on how often the client polls for changes. Many clients can poll at high rates so that the client can quickly learn of changes and reflect them on the client display to achieve a quasi-real time.

The mobile optimization of the Lemonade profile can support both Poll and Push Models.

Today, most of the existing email clients implement a polling model, where the end user is notified of changes to an email account only after the email client polls the server for changes. How long it takes a client to learn of a change on the server is thus dependent on how often the client polls for changes. Many clients can poll at high rates so that the client can quickly learn of changes and reflect them on the client display to achieve a quasi-real time synchronization experience for the end user. The periodic poll model is used on conventional email clients. Because the client must continuously poll the server for changes, the bandwidth requirements can be quite high and the connection quality must be good in order to provide a quasi-real time experience to the user. This also generates additional load on the IMAP server. The periodic poll model is illustrated in FIG. 3.

Another way to achieve synchronization is for the email server to initiate a session with the client when a crucial change to an email occurs, which is the push model. When important events happen to a user's email account, the server informs the client device about the event, and then the client can respond to that event as necessary. In this case, the client device does not need to periodically poll the mail server, so the push model is particularly effective in the mobile computing environment when the cost of constant polling is high. [NOTIFICATIONS] defines the semantics for pushing events to a client. The push model is seen in FIG. 4.

After a client receives a notification that informs it that changes have occurred to a mailbox, it needs to employ a synchronization technique to reflect the server side changes onto the client device. There are many techniques for determining what the changes between a server and client are. In this section, two techniques are presented that aim to keep a client device in sync with a given email account, meaning that the set of messages on the client device is the same as that in the given email account.

IMAPv4Rev1 clients use a state-comparison-based synchronization technique to be in sync with an email account. This technique requires the client to ask the server for information regarding all the folders and all the messages in each folder stored on the server. The client must then compute the difference between the server state and the client device state, and make all necessary changes so that the client device state matches the server state. An example of the interaction between the client and server in the IMAPv4Rev1 protocol for performing a state-comparison-based sync follows. This is described in more details in [IMAP-DISC].

First, the client must retrieve the folders from the server. The client should issue LIST to figure out which folders has to be retrieved. It than uses LSUB to determine which folders are subscribed. For example:
C: A002 LIST “ ” “%”
S: * LIST (\NoInferiors) “/” “Drafts”
S: * LIST 0 “/” “Friends”
S: * LIST (\NoInferiors) “/” “ItNBOX”
S: A0020K completed
C: A003 LSUB “ ” “*”
S: * LSUB ( ) “/” “Drafts”
S: * LSUB ( ) “/” “Friends”
S: * LSUB ( ) “/” “INBOX”
S: A0030K LSUB completed Note, that the client should not use LIST “ ” *, as it might cause too much data to be returned as discussed in [RFC2683] in more detail.

The client must compare its folders with the responses of the command above. If it does not have a folder, it must create that folder on the client device. If there is a folder on the device that is not in any of these responses, then the client must delete that folder. In order to avoid loosing changes performed on the client, the client should apply its changes first. In case when the client has changes to a folder that was deleted on the server, it should ask the user whether the changes should be uploaded to a different mailbox or be discarded (or be configured to automatically do one of the two). Next, the client needs to make sure that the emails in each of its folders match the server. It performs a SELECT and then a FETCH command for each folder. A sample of a SELECT and FETCH command for the inbox is as follows:
C: A003 SELECT OX”
S: * 60 EXISTS
S: . . . more untagged responses with information about the folder
S: A003 OK SELECT completed
C: A004 FETCH 1:* (FLAGS UID)
S: * 1 FETCH (FLAGS (\Answered) UID 120)
S: * 2 FETCH (FLAGS (\Seen) UID 121)
S: . . . flags for messages with message sequence numbers 3-59
S: * 60 FETCH (FLAGS 0 UID 250)
S: A004 OK FETCH completed

The client must go through the full list of email messages in each folder. It must download an email message from this list if it is not already on the client. Any changes to the mutable flags a message must be reflected on the server using IMAP STORE command. Also, the client should remove any emails on the client device not in this list. After performing these operations, the client is in sync with the server.

Another technique is event-based synchronization. Event-based synchronization is used to keep the client device in sync with the server. This method requires that the client has been fully synchronized with the server at some earlier point. In the IMAPv4Rev1 protocol, the client must perform a state-comparison-based sync when it selects a folder, but then it can use event-based synchronization to keep itself in sync after that. Although event based synchronization cannot totally replace state-comparison-based synchronization, it is a faster alternative for the client to maintain synchrony when the server is capable of change tracking for a client.

In event-based synchronization, the server keeps track of what changes have occurred to the email account that are not yet reflected on the client device. Such a change is called an event. When the client finishes processing all events since the last time it was in sync with the server, it is again in sync with the server. Event-based synchronization is particularly effective when the server can push events to the client for immediate processing. In this case, there are likely to be only a small number of events the client needs to process at one time.

Also, when a Lemonade client drops a connection or accidentally disconnects the server can retain the session and cache all events during the time the client is disconnected. When the client reconnects it does not need to perform a state-comparison-based synchronization all over again, and the server sends the list of pending events to the client The Lemonade server MUST support Server-side filtering as described in [NOTIFICATIONS].

The Lemonade server MUST support the rich set of extra functionality over the IMAP server to support extra features for a mobile client described as Lemonade Command Extensions in [EXTENSIONS]. These include:

[1] Compression ?onade CS Profile allows for compression of responses to a command. Preliminary testing results shows significant performance results when the response to FETCH FLAGS or header information are compressed. Details are found in [EXTENSIONS].

[2] Sending emails—The Lemonade server can be used to send email, thus eliminating the need for the Lemonade client to connect to a separate SMTP server. When interfacing with a server that supports LEMONADEDELIVER as discovered via CAPABILITY commands as described in [Extensions], this is the mechanism that SHOULD be used. Otherwise, the client is expected to implement the Lemonade Pull Model.

[3] Support for unstable mobile connections ?er a client drops a connection, the Lemonade server can temporarily maintain the session for the mobile client. During this time, the server caches any events concerning the mobile responsitory while the client is disconnected, which it can then send to the client upon reconnection.

[4] Longer periods of inactivity tolerated—A Lemonade server should wait at least 24 hours before logging out an inactive mobile client and ending its session which may lead to Deny of Service.

[5] Attachments forward/reply behavior—When forwarding/replying to a message from the Lemonade client, the end user may choose to reattach the original's message attachments by just specifying the UID of the original message and specifiers for the required bodyparts. The client need not download the attachments of the original message itself. This is an expected server behavior. It may also be implemented following the Lemonade Pull Model.

[6] Attachments conversion—The Lemonade server can convert attachments to other formats to be viewed on a mobile device. This is an expected server behavior.

[7] PIM—The protocol also provides support for updating personal information on a client device, even when these changes are initiated from another client (i.e. a personal assistant connects to an end user's account from a desktop and changes contact information.) These additional uses are especially useful for mobile devices, where end users need up-to-date information on the fly such as calendaring and address book information.

Mobile operators usually charge users for the time their mobile client gets connected to the Internet and/or for the amount of information sent/received. Thus a mobile client should minimize time it stays connected to its mail server, which suggests that it should disconnect and reconnect frequently.

Also, it is possible that the mobile client unexpectedly leaves area of connectivity, which will require that the client reconnects when connectivity returns.

IMAP can be verbose. Usually, in order to synchronize a client with a server after a disconnect, the client needs to issue at least the following commands: LOGIN/AUTHENTICATE, SELECT and several FETCH commands (see [IMAP-DISC] for more details). Thus, there is a desire to have a quick reconnect facility in IMAP, which will give a mobile client ability to resume a previously abandoned session, without the need to perform the full synchronization sequence as described above.

For mobile clients, the Lemonade Profile exchanges may be transported on HTTP as described in [HTTPBINDINGS].

A Lemonade server MUST responds to all IMAPv4Rev1 commands. A compliant Lemonade server must implement all the commands in IMAPv4 Rev1, with the revisions described in [NOTIFICATIONS] and [EXTENSIONS].

The mobile optimization of the Lemonade profile calls for the same security requirements for an in-response and inband connectivity mode as IMAP. For the outband connectivity mode, servers should use encryption methods for notifications if sensitive information is included in the payload of that notification. When an implementation of Lemonade Mobile Profile is proxy-based, this may create new security issues. These issues are discussed in detail in [EXTENSIONS], because the issues are dependent on the implementation of this protocol rather than inherent to the protocol itself.

Lemonade server to client notifications provides some extensions to the IMAPv4 Rev1 protocol [RFC3501] for optimization in a mobile setting, aimed at delivering extended functionality for mobile devices with limited resources. These notifications support pushing crucial changes actively to a client, rather than requiring the client to initiate contact to ask for state changes.

The Lemonade Server to Client Notifications extends IMAPv4 Rev1 [RFC3501]. The client devices are assumed to be wireless with limited resources. However, this should not be seen as constraining. The Lemonade Server to Client Notifications can be bound to any transport protocol for inband and outband connectivity. These notifications inform the client of changes in an end user's mailbox and define what events and conditions generate notifications, as well as how the server will inform the client of these notifications. In addition, it covers how the client will process these notifications to maintain email synchrony.

The Lemonade profile and Lemonade Server to Client Notification protocol is meant to support mobile client devices with memory and connectivity constraints. Due to these constraints, an end user may want to specify filters to limit the number of notifications sent. These filters separate their emails into different sets that the server should handle differently. All end users have a complete repository, which includes all their email messages that are stored on a server. The end user may want to receive a small subset of these messages on their client device, which are to be included on the mobile device. The messages on the device are split further into two categories, lower priority messages that the user chooses to wait for until it can poll the server and higher priority messages that the user would like to be notified of as soon as possible by the server. All three repositories have the same set of folders.

Formally, a repository consists of a set of folders, and each folder has both a name and a set of messages associated with it. While the three repositories all have folders with the same name, there may be different messages in them. The complete repository consists of all folders of an end user and all the associated emails for each of those folders. Messages in the complete repository that pass the view filter make up the poll repository. An end user can specify exactly one view filter per folder per device. In addition, there is a second layer of filtering, called priority or notification filters, and there is exactly one priority filter per folder per device. The push repository is the set of all the messages in the complete repository that pass both the view and the priority filters. The filter and repository model is shown in FIG. 5.

When the client connects to the server and polls for messages, it can determine what changes have occurred to messages that passed the view filters. Whenever an event occurs to a message that passes the view and priority filters, the server actively pushes a notification to the client.

Lemonade Server to Client Notification assumes extensions of IMAP with the same basic model, where the client connects to the server to open a session to access its email account. A Lemonade client may fetch the contents of the email account or make changes to it just as in IMAP.

A Lemonade server should support multiple mobile devices for each email user, and should allow each device to have one unique event filter and a set of view filters and priority/notification filters. The server only needs to support one connection per mobile device for each email user. A mobile client connects to the Lemonade server by supplying its LOGIN information, and then must inform the server of this mobile client's device ID, which is some unique identifier for the client device. The server and client should agree on what convention to use for this ID, and it could be a hash of IMEI. If no device ID is given, then a regular IMAP session is initiated. The LOGIN information is used to specify a user, while the device ID is needed to specify the mobile client. Associated with the user and device ID is exactly one view filter and exactly one priority/notification filter for each folder. These filters are saved and thus persist across Lemonade sessions. Filters can be modified when a Lemonade session is open.

View filters and priority/notification filters are used to filter out email messages which match certain criteria. If an email passes through the view filter, it is stored in the mobile repository. The syntax for defining a view filter or notification filter includes any combination of most of the search criteria as defined for the SEARCH command of IMAP, in Section 6.4.4 and 7.2.5 of RFC 3501, or a days filter. The days filter filters messages received starting a certain number of days before the current day. The ALL search criteria, when used alone, means that every email event satisfies the criteria. By default, view filters are set to ALL. Whenever a view filter is modified, the client needs to perform a state-comparison-based sync to keep in sync with the mobile repository since the messages in the mobile repository may have changed.

Priority/Notification filters are used to select emails in the mobile repository which match certain criteria. If an email passes through the notification filter, it is stored in the push repository. The syntax for defining a priority/notification filter is discussed below. By default, priority/notification filters are set to NOT ALL to reduce default traffic at the cost of some delays. Because the view filter defaults to ALL and the priority/notification filter to NOT ALL, the mobile repository will mirror the complete repository, but none of the messages are added to the push repository. This implies that the default behavior is equal to the IMAPv4 Rev1 model.

The client does not need to do anything after it resets a priority/notification filter or event filter, instead the server should then only send out notifications that correspond to the most up-to-date filters.

The syntax for defining a priority/notification filter is ALL, NONE, or NEW. A priority/notification filter applies for all folders in a push repository.

ALL—All message events concerning messages of the push repository will be sent to the client, such as if the message becomes seen or deleted.

NONE—No events should be pushed to the client.

NEW—Only events that concern new messages arriving to the push repository should be pushed to the client.

This one event filter applies for all folders.

There are three connectivity models for Lemonade Server to Client Notifications, depending on the capabilities of the Lemonade server, the client, and the connection available between them. These models include in-response, inband, and outband. It is explicitly stated in what situations these three connectivity models arise.

The in-response binding scenario is the most basic one and implements the poll model. In this case the client initiates the commands to the Lemonade server and the server responds to client commands with events. In this case there is no need for a persistent connection between the client and the server. The client opens a connection only when it needs to send commands to the Lemonade server, and that is the only time it is notified of new events. An In-Response Connection is shown in FIG. 6.

An in-response connection can occur in several situations:
[1] HTTP/HTTPS binding
Server Requires: HTTP/HTTPS listener for IMAPv4
Client Requires: HTTP/HTTPS client with IMAPv4 processing
[2] TCP Binding
Server Requires: IMAPv4
Client Requires: IMAPv4+no IDLE

The inband binding scenario corresponds to a reliable push model. In this case the server pushes events to the client whenever they occur. To do so, it must have a reliable means of communication with the client, and the client should be ready to accept such notifications. In this case, there needs to be a persistent connection between the client and the server so that the server can push an event at any time. The client may optionally issue a request to retrieve more information concerning an event. An inband connection is shown in FIG. 7.

An inband connection can occur in the following situations:
[1] TCP Binding, Always connected, IDLE
Server Requires: IMAPv4+IDLE
Client Requires: IMAPv4+IDLE, constant TCP connection
[2] Any other persistent two-way connection
Server Requires: IMAPv4+IDLE
Client Requires: IMAPv4+IDLE, constant connection

The outband binding scenario corresponds to an unreliable push model. In this case the server pushes events to the client whenever they occur, to the best of its ability. To do so, it should be able to send messages to the client without the need for a persistent connection. However, the outband channel can possibly lose and reorder messages, and there are no timing guarantees. Examples of out-band channels include SMS, JMS, WAP Push, and UDP. As in the inband scenario, the client may optionally open a Lemonade session over an inband or in-response connection and send a command as a result of receiving an event. An outband connection is shown in FIG. 8.

Outband connectivity occurs in the following situations:
[1] A notification service from the server to the client
Server Requires: A notification generator.
Client Requires: A notification processor.

Whenever a client device opens a new session, it must perform a state-comparison-based sync with the email server so that its state is the same as the mobile repository. Since the client has no way of directly detecting only changes to the repository since the last login, it needs to retrieve information about every message in the mobile repository and calculate the changes itself. After that point, the client can use event-based synchronization to keep the device in sync.

The Lemonade server can issue a session and track changes to a selected folder for the duration of a session. Until the session is expired, the server must log all events that occur while a client is offline. This way, if the client temporarily loses a connection, it does not have to worry about missing any events and needing to perform another state-comparison-based sync. A client does have the option though to prematurely end a session by issuing a LOGOUT command. Additionally, Lemonade clients can remain inactive for at least twenty four hours without being logged off the server and without the session expiring.

The client can receive the following untagged responses from the server using the following syntax for example in message events sent during an inland and in response mode:

[1] The client receives an EXISTS/RECENT event from the server indicating a new message.
S: * 501 EXISTS
S: * 1 RECENT

Next, the client retrieves this new message using a FETCH command.
C: A02 FETCH 501 (ALL BODY[ ])
S: * 501 FETCH . . .
S: A02 OK FETCH completed

[2] The client receives an EXPUNGE event from the server from a message has been permanently removed from a folder.
S: * 25 EXPUNGE

The client deletes this message from the client device, as it has been removed permanently from the folder. The client does not need to send any command back to the server.

[3] The client receives an untagged FETCH event from the server, which can contain just FLAG information if the event is regarding an old message or possibly other information if the event is regarding a new message. This event is received if a message's flags are changed, or in response to a new message if the user's preferences are set to do so.
S: * 101 FETCH (FLAGS (\Seen \Deleted))

The client saves the information contained in this response accurately in the client device.

The Lemonade Server to Client Notifications also define events to be sent by the server to the client. These events notify the client when there are changes to messages that match an end user's view filters and notification filters, as well as any changes to a client's email folders. The syntax defined in this section is an abstract syntax, and payloads may vary according to the communication mechanism used. The normative appendix of this document describes some specific payloads.

The UID of email messages MUST not change across sessions. Changing the UID of email messages requires a heavy computational burden on the mobile client, so the server should avoid doing so. The UID of email messages MUST not change for the duration of a session.

In a Lemonade session, the client can only access messages in the mobile repository. This affects the messages returned by FETCH, UID FETCH, etc. Message sequence numbers reflect the relative position of messages within the given folders of the mobile repository, so the message sequence number of an email while logged in to Lemonade may also differ from IMAP. When returning information about the email account, only messages in the mobile repository are taken into account.

The server should implement the IDLE command from RFC 2177. When the client issues this command, the server can push changes to a folder to the client. The server may replace the EXISTS/RECENT message with an untagged FETCH command as specified in [EXTENSIONS]. The client should fire this command while in-session to enter inband mode, where the server will actively push notifications to the client.

The LEMONADESETPREF command is described in [EXTENSIONS]. It allows a user to define certain configuration parameters, while the LEMONADEGETPREFS command allows a user to retrieve the configuration values. Any server that implements these commands must respond with LEMONADEPREF as one of the capabilities in response to a CAPABILITY command. It must also announce the values these parameters can be set to in the LEMONADEPROVISION command (See [EXTENSIONS]). These parameters affect how outband notifications are sent to the client, as well as the format for sending new event notifications. If the server supports LEMONADEPREF they are required to support all of the following preferences with at least one value to set each preference to. They are described in [EXTENSIONS].

The LEMONADEFILTER command allows users to set up view filters and priority/notification filters. LEMONADEFILTER can be fired when the state is AUTHENTICATED or SELECTED. The first argument to this command is the folder that that filter should be applied to, or “ALL” for all folders. Next the user specifies “V”, “N”, or “B” to set either a view filter or a priority/notification filter, or both. Following this, it must specify the filter criteria using a combination of search criteria as defined for the SEARCH command of IMAP, in Section 6.4.4 and 7.2.5 of RFC 3501, or the days filter. The ALL search criteria, when used alone, means that every email message satisfies the criteria. Or it can specify “V” or “N” to get a view filter or priority/notification filter. In this case, the last argument is “GET” to retrieve the filter. By default, view filters are set to ALL, while priority/notification filters are set to NOT ALL. This means that the mobile repository includes all the messages in the complete repository, but none are pushed to the client, which is the IMAPv4 Rev1 model. Exactly one view filter and one priority/notification filter is associated with each folder for each device. When a new view filter or priority/notification filter is created, it replaces the previous filter for that folder. When a view filter is modified, the client needs to perform a state-comparison-based sync on the client in order for the device to be in sync with the mobile repository. The server always sends only notifications that correspond to the most up-to-date view filters and priority/notification filters. All filters persist across Lemonade sessions; once set, a filter on a folder applies until the user changes it.

Lemonade introduces a filter, the day's filter, which allows a user to specify from how many days before today it would like to see emails. To see only today's email, a 0 should be used for the int.

lemonadefilter_cmd=tag SP “LEMONADEFILTER” SP (“ALL”/folder) SP ((“V”/“N”/“B”) SP lemonadefilter_criteria)/((“V”/“N”) “GET”)
lemonadefilter_criteria=(IMAPv4Rev1_searching_criteria/days_filter)
[SP lemonadefilter_criteria] days_filter=“DAYSBEFORETODAY” SP int
Valid States: AUTHENTICATED or SELECTED
Responses: untagged responses: lemonadefilterGet_resp
lemonadefilterGet_resp=“*” SP “LEMONADEFILTER” SP folder SP (“V”/“N”)
lemonadefilter_criteria
Result: OK—filter created
NO—can't create the filter
BAD—invalid arguments

Example: The client creates a priority/notification filter for all messages in the Inbox from “John” since Jun. 1, 2003.
C: A001 LEMONADEFILTER INBOX P SINCE 1-Jun.-2003 FROM “John”
S: A001 OK LEMONADEFILTER completed

Example: The client asks for the view filter for all the folders.
C: A001 LEMONADEFILTER ALL V GET
S: * LEMONADEFILTER/INBOX V ALL
S: * LEMONADEFILTER/TRASH V NOT ALL
S: A001 OK LEMONADEFILTER completed

Example: Stop notifications on a particular device, fired while in AUTHENTICATED mode.
C: A001 LEMONADEFILTER ALL P NOT ALL
S: A001 OK LEMONADEFILTER ALL P NOT ALL completed

The protocol calls for the same security requirements for an in response and inband connectivity mode as IMAP. For the outband connectivity mode, servers should use encryption methods for notifications if sensitive information is included in the payload of that notification. When an implementation of Lemonade is proxy-based, this may create new security issues because the issues are dependent on the implementation of this protocol rather than inherent to the protocol itself. The event payload for a Lemonade session follows the general format explained above and is in clear text.

The suggested payload for notifications is that suggested by the OMA, see [OMA-EN]. This notification informs the client that some push event has happened on the server, so it must connect to fetch the information. When the client finally connects, the Lemonade server has opportunity to send other pending events for this client. Example: new message arrives on the server and this is notified via outband.
S: pushes SMS with the following text:
<emn mailbox=“mailat:joe@foo.com”
timestamp=“2004-02-20T06:40:00Z”>
</emn>

C: needs to connect and send any command to get the pending events and act upon them.
C: A00 Login joe password
S: * SESSION SELECTED
S: * FOLDER INBOX
S: * 100 EXITS
S: * 87 EXPUNGE
S: * 90 FETCH (FLAGS \Seen)
S: A00 OK LOGIN completed

C: must now act on the events on the order they are received, meaning, first perform a FETCH to get new message, then expunge message 87 and change flags of message 90.

Each time a client logs into a new Lemonade session, it must perform a state comparison-based sync. To synchronize with the server, the client needs to fetch all the new messages, and all the flags of the old messages. The client has N messages in a given folder with highest UID=X and is disconnected from the Lemonade server. It connects to the server and performs the following command:

First, it retrieves all the new messages.
C: A01 UID FETCH X+1:* ALL
S: * m FETCH . . .
S: . . . <more new messages if they exist>
S: A01 OK FETCH completed

The client stores all this information on the device and displays it. Next, it wishes to sync up the old messages.
C: A02 FETCH 1:m-1 (UID FLAGS)
S: * 1 FETCH (UID 3242 FLAGS (\Seen . . . ))
S: . . . <info for 2 through n-1>
S: * n FETCH (UID 3589 FLAGS (\Seen . . . ))
S: A02 OK FETCH completed

During a Lemonade session, the client will receive events in the form of untagged EXISTS, RECENT, EXPUNGE, or FETCH responses. The client must respond to these events. Sometimes, it will receive these events by polling, by issuing a Lemonade command, such as NOOP. It can also use IDLE so that the server can push events to the client. The example following shows how the client acts during an IDLE command, but it should also take the same actions (minus firing and exiting IDLE mode) when it receives these events through polling. A client can choose to issue an IDLE command to get events pushed to it, or it can receive events from polling using NOOP or any other IMAP command.

First the client issues the IDLE command:
C: A02 IDLE
S: +Ready for argument

Now the client can receive any of the three following untagged responses from the server.

When the client receives an EXISTS/RECENT response from the server:
S: * 501 EXISTS

First, the client must exit from this IDLE command.
C: DONE
S: A02 OK IDLE completed

Next, the client retrieves this new message using a FETCH command.
C: A02 FETCH 501 ALL
S: * 501 FETCH . . .
S: A02 OK FETCH completed

The client returns to IDLE mode by issuing another IDLE command.
C: A03 IDLE
S: +Ready for argument

When the client receives an EXPUNGE response from the server:
S: * 25 EXPUNGE

The client deletes this message from the client device, as it has been removed permanently from the folder. The client can remain in IDLE mode.

When the client receives an untagged FETCH response from the server, either signally a flag change to an old message or a new message:
S: * 101 FETCH (FLAGS (\Seen \Deleted))

The client updates the information on the device for this message appropriately.

The Internet Society has proposed a WINDOW extension to the Internet Message Access Protocol [IMAP4] that permits windowing of the results of specific IMAP commands, so that clients can retrieve the results in ranges to implement paging of results or virtual scrollbars. This eliminates the need to get and manage the entire result set, improving scalability for large mailboxes and slow connections. Although the proposal addresses a different problem than the present invention, the syntax used therein is similar to that proposed and used in the present invention and is presented for purposes to assist in providing a better understanding of the invention.

The WINDOW extension is present in any IMAP4 implementation which returns “WINDOW” as one of the supported capabilities in the CAPABILITY command.

The WINDOW extension specifies one new command (with a number of variants) and introduces one new untagged response (with a number of variants).

The WINDOW command is an optimization for scalability purposes; clients can provide the same functionality, albeit more slowly, by using existing commands.

The SEARCH [IMAP4], SORT [SORT] and THREAD [THREAD] commands in IMAP4 return a list of results equal to the size of the input window. The input window is determined by the parameters to each command. For example, the SEARCH command can limit its input window by using sequence number or UID number ranges as parameters to the SEARCH:

Example: C: A999 SEARCH UNSEEN 10:20
S: * SEARCH 1 2 4 6
S: A999 OK SEARCH completed

In the above example, an input window of messages with sequence numbers in the range 10 through 20 are the only ones considered by the SEARCH command. This limits the output to a maximum of 11 hits. The SORT and THREAD commands both take search criteria as parameters, and thus can also accomplish input windowing if desired.

While input windowing can reduce the number of results returned, it does not offer a way to window the results based on their output ordering or size. The design goal of the WINDOW extension is to allow clients to do output windowing of the results of SEARCH and SORT commands, and to provide an extensible mechanism for future IMAP command extensions that return results as a list of sequence numbers or UIDs.

In order to keep the WINDOW extension simple, the THREAD command is not included as one of the commands that WINDOW works with, due to the hierarchical nature of the THREAD command results.

This extension makes the following changes to the IMAP4 protocol:

(a) Adds a new WINDOW command which takes one of four forms: (i) The first form, WINDOW SET, takes an optional sub-command and is used to initiate or cancel the windowing mechanism on the server. When initiating a window, the server creates an output results set consisting of all messages returned by the sub-command, in their appropriate ordering. The server returns the maximum size of the output results set as well as the position of the first unseen message in the output results set. (ii) The second form, WINDOW SHOW, takes parameters that allow the client to precisely specify the output window range. This command causes the server to return the message numbers for messages in this output window, which is a subset of the entire output results set. (iii) The third form, WINDOW UPDATE, causes the server to update the output results set to reflect any changes to the state of the mailbox since the last WINDOW SET <sub-command> command was issued. (iv) The fourth form, WINDOW MAP, the client provides a set of ordered message sequence numbers or UIDs and the server returns the output positions of those messages in the current output results set. For example, this allows a client to preserve user message selections across WINDOW UPDATEs or other mailbox changes.

(b) Adds a new WINDOW untagged response which takes one of three forms: (i) The first form, WINDOW SET, returns the size and position of the first unseen message in the output results set. (ii) The second form, WINDOW, returns the output window range. (iii) The third form, WINDOW MAP, returns the mapping results from message sequence number or UIDs to output positions in the current output results set.

(c) Modifies the EXPUNGE untagged response to include the output position of the message being expunged, when a WINDOW SET operation is in effect.

Input Window means the set of messages used as input to a SEARCH or SORT command. In the case of SEARCH this can be controlled via the message number or UID range search criteria. In the case of SORT this is controlled by the search criteria used with those commands.

Output Results means the set of ordered message numbers or UIDs that are the results of a SEARCH or SORT command.

Output Position means the position of a message in the output results, a number from 1 to <n> where <n> is the total number of messages in the output results.

Output Window means a contiguous range of messages in the output results that the client wishes to know about.

Anchor means a specific message that the client wants to appear at a particular osition in the output window, requiring the server to determine the actual output window range to accommodate this requirement. For example, when first opening a mailbox, the client may want to position the first unseen message at the top of the list presented to the user by scrolling its graphical window to the appropriate place.

Anchor Offset means the position of the anchor message in the output window, relative to the start or end of the output window.

The examples below will all use the following output results set for consistency. There are a total of 20 messages in this set and the first unseen message in the set has a sequence number of 14 and appears at output position 3.

Output results:
11 12 14 16 30 22 24 13 15 31 10 44 21 23 42 41 37 27 26 25

The output results after an update. There are a total of 14 messages in this set and the first unseen message in the set has a sequence number of 22 and appears at output position 6.

Output results after an update:
11 12 14 16 30 22 24 13 15 31 10 44 21 23

The WINDOW command is only available when the server is in ‘selected state’ [IMAP4]. Thus a successful SELECT or EXAMINE command MUST have been issued before WINDOW can be used. If a client attempts to use WINDOW while the server is not in ‘selected state’, then the server MUST respond with a BAD response.

To avoid ambiguities when messages are expunged from the mailbox, the server MUST NOT send untagged EXPUNGE responses whilst a WINDOW command is in progress,

The WINDOW command takes one of four forms.

Arguments: OPTIONAL sub-command and associated arguments:
this draft currently only allows the SEARCH and
SORT [SORT] commands as the sub-commands.
Responses: REQUIRED untagged responses: WINDOW SET
Result: OK—window set completed, now in window state
NO—window set failure
BAD—command unknown or arguments invalid

The WINDOW SET command is used to define the set of messages that form the output results. This set is determined by the result of the sub-command, and is ordered according to the sub-command. The server stores the output results, which are used to return the data the client may request using other WINDOW commands. The server MUST return an untagged WINDOW SET response to the WINDOW SET command, indicating the total number of messages in the output results, as well as the output position number of the first unseen message in the output results, or zero if there are no unseen messages in the output results.

Example: C: A999 WINDOW SET SEARCH FROM “Smith”
S: * WINDOW SET 20 3
S: A999 OK WINDOW SET completed

In this example an output results set on a SEARCH command is created. The output results have a total of 20 messages in it, and the first unseen message is at output position 3 in the output results.

A WINDOW SET command with no arguments is used to cancel an earlier WINDOW SET with a sub-command. This allows a client to turn off the windowing behaviour.

Arguments: the message number or starting position of the anchor message, the anchor position within the output window, the size of the output window to return.
Responses: REQUIRED untagged responses: WINDOW
Result: OK—window show completed
NO—window show failure
BAD—command unknown or arguments invalid

The WINDOW SHOW command is used by the client to retrieve portions of the output results defined by an earlier WINDOW SET command. If the server is in selected state and there was no previous WINDOW SET command, or the WINDOW SET command was cancelled, then the server MUST respond with a BAD response.

The WINDOW SHOW command takes three parameters:

a) An identifier indicating the position of the anchor message in the output window. The client can specify the message by either its sequence number, UID or position in the output results set. This is done by using a single character before the numeric value to indicate what type it is: ‘S’ for sequence number, ‘U’ for UID and ‘P’ for output position.

b) The requested anchor position where the anchor message should appear in the output window, relative to either the start or end of the output window. The server MUST return a BAD response if the requested anchor position exceeds the size of the output window, as specified in the third argument.

c) The size of the output window. If the size provided by the client exceeds the size of the output results, the server MUST return a BAD response.

The server MUST respond with an untagged WINDOW response indicating the output position of the first message in the output window range, followed by the message numbers of the messages in the range requested by the client. In some cases the anchor may not appear at the relative offset in the output window requested by the client, because the offset would result in the output window exceeding the range of the output results.

Example: C: A999 WINDOW SHOW P 3 +0 10
S: * WINDOW 3 14 16 30 22 24 13 15 31 10 44
S: A999 OK WINDOW SHOW completed

In this example the client requests the server to return the message sequence numbers for 10 messages, anchored on output position 3 (the first unseen message), with the anchor set to appear first in the output window. The server responds with the output position of the first message in the output window range, followed by the 10 message sequence numbers corresponding to the requested messages—the message with sequence number 14 is the anchor and the first unseen message in the output results.

Example: C: A999 WINDOW SHOW P 20-0 10
S: * WINDOW 11 10 44 21 23 42 41 37 27 26 25
S: A999 OK WINDOW SHOW completed

In this example the client requests the server to return the message sequence numbers for the last ten messages in the output results. This is accomplished by setting the anchor to the last output position, and requesting the anchor to appear last in the output window.

Example: C: A999 WINDOW SHOW S 14 +5 10
S: * WINDOW 1 11 12 14 16 30 22 24 13 15 31
S: A999 OK WINDOW SHOW completed

In this example the client requests an output window centered on the message with sequence number 14. However, that message actually appears at output position 3, so the specified anchor position cannot be accommodated, so the output window contains the anchor at position 3 instead of the requested position 5 from the start.
Arguments: None.
Responses: REQUIRED untagged responses: WINDOW SET
Result: OK—window update completed
NO—window update failure
BAD—command unknown

The WINDOW UPDATE command is used to update the output results created by a previous WINDOW SET command. This is needed because WINDOW SET's output results are static—i.e. they do not change even when the state of messages changes, or new messages are added to the mailbox. In order to account for change to the mailbox, the client must use the WINDOW UPDATE command. If the server is in selected state and there was no previous WINDOW SET command, or the WINDOW SET command was cancelled, then the server MUST respond with a BAD response.

The server MUST return an untagged WINDOW SET response to the WINDOW SET command, indicating the total number of messages in the new output results, as well as the output position number of the first unseen message in the new output results, or zero if there are no unseen messages in the new output results.

Example: C: A999 WINDOW UPDATE
S: * WINDOW SET 14 6
S: A999 OK WINDOW UPDATE completed

In this example the new output results have a total of 14 messages in it, and the first unseen message is now at output position 6 in the new output results.
Arguments: Message number range.
Responses: REQUIRED untagged responses: WINDOW MAP
Result: OK—window map completed
NO—window map failure
BAD—command unknown

The WINDOW MAP command allows a client to determine the output positions of messages based on their sequence number or uid (if the UID command modifier is also used). This is required to help preserve a user's message selection state before and after a WINDOW UPDATE command is used.

If the server is in selected state and there was no previous WINDOW SET command, or the WINDOW SET command was cancelled, then the server MUST respond with a BAD response.

The server MUST return an untagged WINDOW MAP response to the WINDOW MAP command, indicating the new output positions of the requested messages, corresponding to the range used as the argument to the command. The server MUST return an output position number of zero for any messages that are no longer in the output results.

If the message number argument specifies one or more messages that are not in the output results set, the server MUST respond with a BAD response.

Example: C: A999 WINDOW MAP 5, 14:16, 22, 24
S: * WINDOW MAP 0 3 9 4 5 6
S: A999 OK WINDOW MAP completed

In this example the client requests the output positions of messages with sequence numbers 5, 14, 15, 16, 22 and 24. Message 5 is not in the output results set, so its output position number is zero.

The IMAP UID command is used to modify the meaning of another command and/or the untagged results of a command. The WINDOW extensions extends the UID command to accept certain WINDOW commands as outlined below.

The UID WINDOW SHOW causes the untagged WINDOW response for the WINDOW SHOW command to contain message uids rather than message sequence numbers.

The UID WINDOW MAP causes the message number range argument to the WINDOW MAP command to be interpreted as message uids rather than message sequence numbers.

The WINDOW SET untagged response is used to inform the client of the total number of messages in the output results set and the output position of the first unseen message in the output results, or zero if no unseen message is present in the output results. The WINDOW SET results can only occur as the result of a WINDOW SET or WINDOW UPDATE command.

The WINDOW untagged response returns the output position of the first message in the requested output window, followed by the message numbers of the messages in the requested output window. The message numbers may be either sequence numbers or uids depending on whether the UID command modifier is used. The WINDOW response can only occur as the result of a WINDOW SHOW command.

The WINDOW MAP untagged response returns the output positions of messages in the output results, ordered according to the ordering of message numbers in the WINDOW MAP command. The WINDOW MAP response can only occur as the result of a WINDOW MAP command.

When a WINDOW SET command is in effect, the server MUST modify any untagged EXPUNGE responses it sends to the client to include the output position of the message being expunged, or zero if the message being expunged is not in the output results. After each EXPUNGE response the output positions for the current WINDOW SET must be readjusted to account for the expunged message. When an untagged EXPUNGE response with a non-zero output position is seen by the client, the client MUST adjust its output window and output results state to take account of the expunged message.

Example: C: A999 NOOP
S:* 1 EXPUNGE 0
S: *10 EXPUNGE 1
S: * 10 EXPUNGE 1
S: A999 OK

In this example three messages are expunged from the mailbox. Message number 1 is not part of the previously determined output results so its output position is shown as zero. Message number 11 was at output position 1, and message number 12 was at output position number 1 after message number 11 was expunged.

The following syntax specification uses the Augmented Backus-Naur Form (ABNF) notation as specified in [ABNF]. Non-terminals referenced but not defined below are as defined by [IMAP4]. Except as noted otherwise, all alphabetic characters are case insensitive. The use of upper or lower case characters to define token strings is for editorial clarity only. Implementations MUST accept these strings in a case-insensitive fashion.

window-set-cmd=“WINDOW SET” SP window-set-arg

window-set-arg=search/sort/OTHER
; search is defined in [IMAP4]
; sort is defined in [SORT]
; OTHER reserved for future definition

window-update-cmd=“WINDOW UPDATE”

window-set-resp=“*” SP “WINDOW SET” SP number SP number

window-show-cmd=“WINDOW SHOW” SP anchor-pos
SP anchor-rel SP nz-number

anchor-pos=(“S”/“U”/“P”) SP nz-number
; “S” indicates sequence number
; “U” indicates uid
; “P” indicates output position

anchor_rel=(“+”/“−”) number
; “+” indicates offset from start
; “−” indicates offset from end

window-resp=“*” SP “WINDOW” SP nz-number *(SP nz-number)

window-map-cmd=“WINDOW MAP” SP set

window-map-resp=“*” SP “WINDOW MAP” SP number *(SP number)

message-data /=nz-number SP “EXPUNGE” SP number
; modifies [IMAP4] EXPUNGE response
; to return output position when
; WINDOW SET is in effect

### SUMMARY OF THE INVENTION

The present invention provides a way to allow the user to restrict message sets per folder. The invention allows a mail client to offload the burden of automatically constraining the mail content seen at the mobile device. The constraints are fully configurable and manageable by the client at a per mailbox level.

There are numerous advantages to the invention including that of a less cluttered mail box and the constraining criteria is user selectable and dynamically configurable.

### DESCRIPTION OF THE DRAWINGS

FIG. 1 is a functional block diagram of a Lemonade Pull Model.

FIG. 2 is a functional block diagram of a Lemonade Client-Server Profile Model.

FIG. 3 is a functional block diagram of a Lemonade Periodic Poll Model.

FIG. 4 is a functional block diagram of a Lemonade Push Model.

FIG. 5 is a functional block diagram of a Lemonade Filter and Responsitory Model.

FIG. 6 is a functional block diagram of a Lemonade In-Response connection.

FIG. 7 is a functional block diagram of a Lemonade Inband connection.

FIG. 8 is a functional block diagram of a Lemonade Outband connection.

FIG. 9 is a flowchart showing the major functional steps of the mail filtering method of the present invention.

FIG. 10 is a functional block diagram showing the major functions of the mail constraint filter of the present invention.

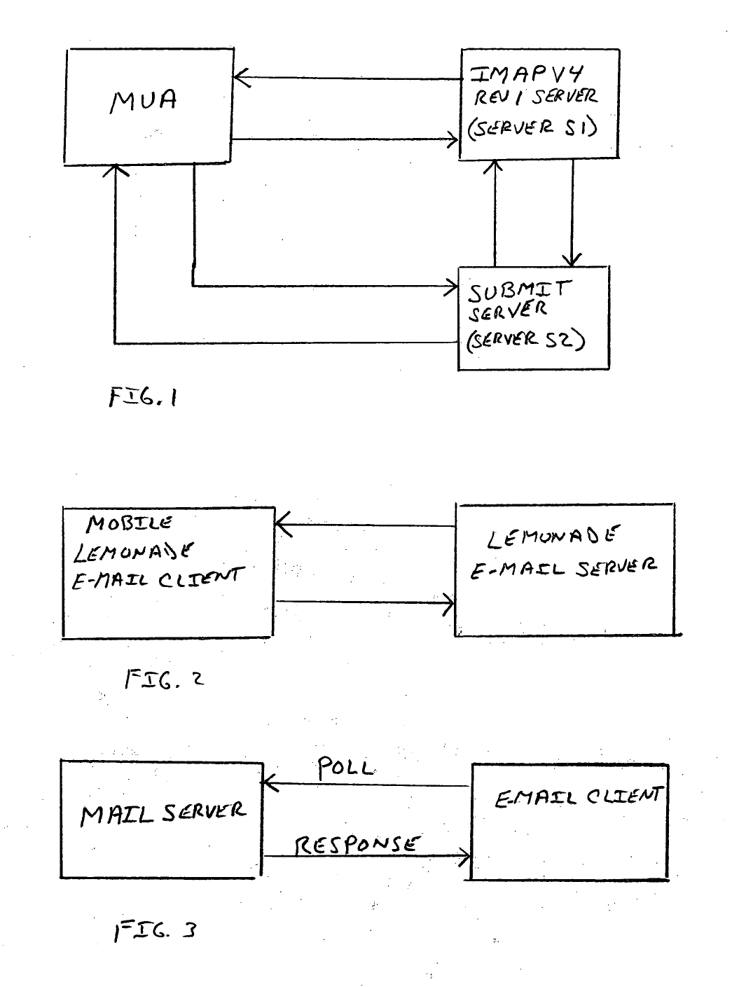

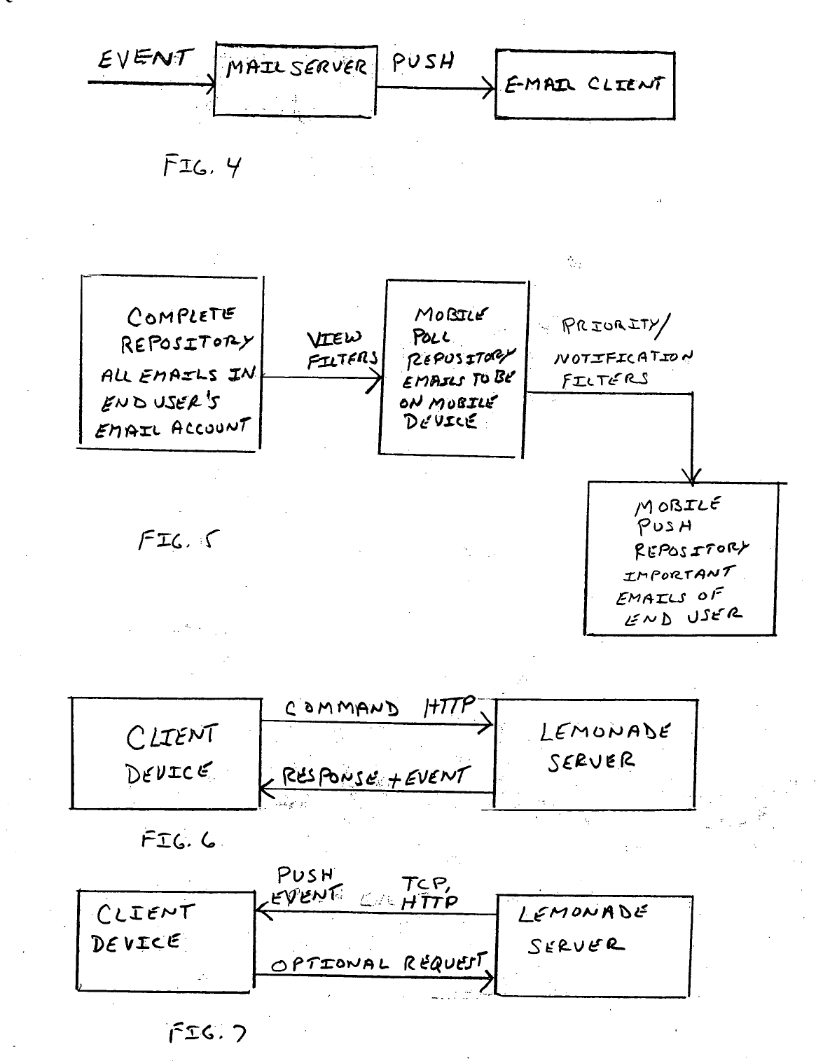

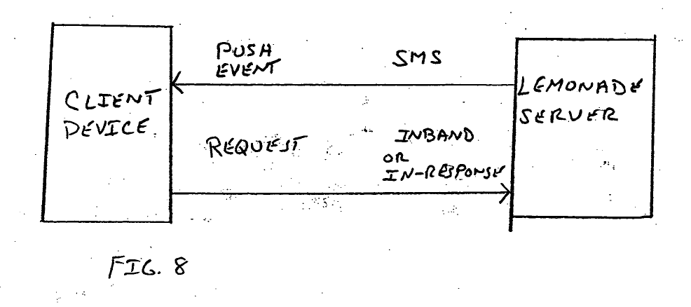

### DESCRIPTION OF THE INVENTION

The invention extends existing mail access technologies. Specifically it extends the IMAP protocol and can be used in a broad range of mobile e-mail clients. An IMAP Extension for MSGFILTER is proposed to carry out the invention.

The purpose of this extension is to allow a client visibility to a constrained message set while performing normal IMAP commands in the Selected state. The benefits to a client are several and include:
1) Bandwidth reduction
2) Processing effort reduction
3) Memory consumption reduction

The target set of clients are those with limited resources such as mobile devices.

In addition, the extension more easily allows the client to achieve a user experience using selective information. This is the notion that when a client becomes mobile the desire is to only deal with a very select set of information in a controlled fashion.

Although it is possible that much of the functionality defined in the invention might be accomplished using a combination of the IMAP SEARCH command and client logic, the present invention provides an optimization that allows the client to achieve this functionality more efficiently.

Some of the goals of the invention are:

1) Extend IMAP functionality in an as minimalistic a way as possible.

2) Allow the set of messages that are part of a filter set to be modified while the filter set is in effect.

3) Minimize load on the server. This is accomplished by requiring the filter set to be transient during the life of the session. This does not mean that the same Filter Set cannot be active on more than one session at a time.

If a server supports the message filtering extension then the keyword MSGFILTER is returned in the capability string.

Definitions used in the Disclosure:

Filter Set—A set of UIDs that are the result of applying a collective group of FILTER SET commands. This set is what is visible when one or more FILTER SET commands are in force. This visibility constraint envelopes all commands issued during the session.

Filter Set Identifier—This is a name that refers to a profile that defines a set of criteria used to constrain the FILTER SET to a set of UIDs. How this is accomplished is outside the scope of this document. Where these criteria are stored is outside the scope of this document.

Commands

All commands defined in this extension are only valid in the Selected state. FILTER SET Command

Arguments: OPTIONAL Sub-Command with arguments. The allowed sub commands are SEARCH, UID and TAG. The SEARCH command can be followed by all associated SEARCH arguments. The TAG command MUST be followed by an identifier. The UID sub command MUST be followed by one or more numeric numbers.

Responses: REQUIRED untagged responses: FILTER SET and EXISTS

Result: OK—filter set completed, now in filter state

NO—filter set failure

BAD—command unknown or arguments invalid

A FILTER SET command will restrict the set of UIDs that are visible to the client. The three forms allow the FILTER SET to be changed during the session. The total FILTER SET is an accumulation of all FILTER SET commands issued during the session. The accumulation is not a simple UNION.

The search command behaves as if it was preceded by the UID prefix command. A SEARCH Sub-Command will result in a set of UIDs that match the search criteria.

A TAG Sub-Command will result in a set of UIDs that match some external set of criteria. The argument pasted to the this Sub-Command is a FILTER SET INDENTIFIER.

A UID Sub-Command takes two forms. The UID ADD form and the UID REMOVE form. They impact the FILTER SET as expected; ADD adds the given UID set to the FILTER SETand REMOVE removes the given UID from the FILTER SET. Multiple FILTER SET commands may be issued during a single session. The rules of accumulation are:

1) TAG Sub-Commands MUST replace ALL previous Sub-Commands, including previous TAG Sub-Commands.

2) New SEARCH sub-commands MUST replace a previous SEARCH Sub-Command. New SEARCH sub-commands MUST union with previous TAG commands.

3) UID Sub-Commands are always cumulative. Multiple UID ADD Sub-Commands will increase the Filter Set, while UID REMOVE Sub-Commands will reduce the FILTER SET if the specified UID was already in the set.

FILTER SETS are transient. A FILTER SET only lasts for the duration of the session. A new Session requires the re-establishment of the FILTER SET. An EXISTS response is sent as the first response in a FILTER SET. It represents the total number of messages visible after the application of the latest FILTER SET. An Example follows:
C: 1 SELECT INBOX
S: * 50 EXISTS
S: * 0 RECENT
S: . . .
S: 1 OK [READ-WRITE] SELECT Completed
C: 2 FILTER SET SEARCH SINCE “10-Sep.-2004”
S: * 3 EXISTS
   S: * FILTER SET 76 78 90
   S: 2 OK FILTER. SET Completed
   Some time goes on, and the client wishes to remove from consideration UID 90. Also, in the mean time a new mail has arrived:
. . . >
C: 3 FILTER SET UID REMOVE 90
S: * 3 EXISTS
S: * 1 RECENT
   S: * FILTER SET 76 78 95
   S: 3 OK FILTER SET Completed
C: 4FETCH
   For Example: C: 1 SELECT INBOX
S: * 50 EXISTS
S: * 0 RECENT
S: . . .
S: 1 OK [READ-WRITE] SELECT Completed
C: 2 FILTER SET TAG TravelingProfile
S: * 5 EXISTS
   S: * FILTER SET 78 80 90 91 98
   S: 2 OK FILTER SET Completed
   Responses
   FILTERED Response
   While there are FILTER SETS in effect in a session all normal IMAP commands are still legal. A FILTERED response is returned when issued to communicate to the client that the current set of responses are representative of a FILTER SET and not the total set of messages that may have been returned had the FILTER SET not been in effect.
   The FILTERED response is returned when any command is issued in the Selected state and the sequence or UID arguments are sets that may include numbers not explicitly asked for by the client.
   An Example follows: C: 1 FILTER SET TAG TravelingProfile
S: * 5 EXISTS
   S: * FILTER SET 78 80 90 91 98
   S: 1 OK FILTER SET Completed
C: 2 UID FETCH 91 FLAGS
S: * 4 FETCH (FLAGS (\Seen) UID 91)
S: 2 OK FETCH Completed
C: 3 UID FETCH 91:* FLAGS
S: * OK [FILTERED] Response may have been filtered
S: * 4 FETCH (FLAGS (\Seen) UID 91)
S: * 5 FETCH (FLAGS (\Seen) UID 98)
S: 3 OK FETCH Completed
   FILTER SET Response
   When a FILTER SET command is issued the resulting set of message UIDs is communicated to the client via the FILTER SET response. The response always reflects the accumulated FILTER SET. This requires that each response always contain the exact set of UIDs that are the result of all FILTER SET commands during this session.
   Formal Syntax as defined by the present invention:
   mailbox-data=“FILTER SET” SP *(SP nz-number) mailbox-data is as defined in [IMAP4];
   nz-number is as defined in [IMAP4]
   resp-text-code=“FILTERED” resp-text-code is as defined in [IMAP4]
   command-select=filter_set

; command-select is as defined in [IMAP4]. The filter-set variable is added to the already existing set of commands in the Selected state.

filter-set=“FILTER” SP “SET” SP (search/uid-set/tag-set); search is as defined in [IMAP4]

uid-set=“UID” SP (“REMOVE”/ADD”)*(SP nz-number)

tag-set=“TAG” SP astring

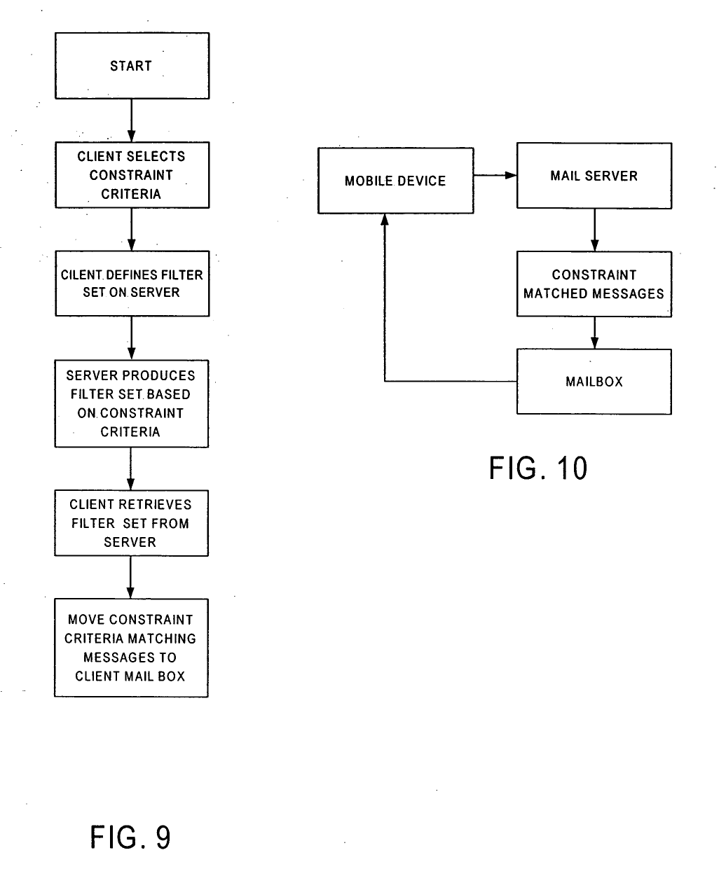

The following is presented for illustrative purposes as an example of the invention with reference to FIGS. 9 and 10.

1) A user defines a set of constraint criteria for what mail the user wants to see on the mobile phone. The user inputs the constraint criteria via the user interface or through possibly a selection of pre-established criteria constraints that the user wishes to invoke as a filter.

2) Mobile software communicates this constraint to the mail server via the defined IMAP protocol extension as set forth for example above.

3) The server responds with the IDs of the current messages matching the constraint criteria.

4) Now the session is completely constrained. All communication from the server to the client will be constrained to this set of messages only. It will appear to the user that these are the only messages in the folder when in fact there may be more.

The operation of the invention can be checked by seeing if the mailbox presents fewer mail messages when viewed on a mobile device compared to a desk-top mail client. In other words if when viewing the exact same mailbox the number of messages appear and disappear based on which mail client the mailbox is viewed from.

1. Method comprising the steps of:
selecting constraint criteria to define a filter set;
entering the constraint criteria on a mobile device;
retrieving from a server messages meeting the constraint criteria, and viewing the constraint matching messages on the mobile device.

2. A system for carrying out the method as defined in claim 1.

3. A software application product comprising computer code for carrying out the method as defined in claim 1.
